(19) United States
(12) Patent Application Publication
(10) Pub. No.: US 2015/0318878 A1
(43) Pub. Date: Nov. 5, 2015

(54) AVOIDING SELF INTERFERENCE USING CHANNEL STATE INFORMATION FEEDBACK

(71) Applicant: Aruba Networks, Inc., Sunnyvale, CA (US)

(72) Inventors: Sathish Damodaran, San Jose, CA (US); Sachin Ganu, San Jose, CA (US); Maruthi Bathina, Fremont, CA (US)

(73) Assignee: Aruba Networks, Inc., Sunnyvale, CA (US)

(21) Appl. No.: 14/266,626

(22) Filed: Apr. 30, 2014

(51) Int. Cl. H04B 1/04; H04B 7/04

(52) U.S. Cl. CPC H04B 1/0475; H04B 7/04

(57) ABSTRACT

Disclosed herein is a system, apparatus, and method for reducing self-interference within a wireless network device using channel state information feedback and beamforming techniques. The self-interference within a device may be reduced by first transmitting, by a first circuitry, a first set signals using a first radiation pattern through a first set of antennas coupled with the first circuitry. Then, based on feedback information associated with the first set of signals detected by a second circuitry of the device, a second radiation pattern to be used by the first circuitry and the first set of antennas that reduces receipt of signals by the second circuitry that are transmitted by the first set of antennas or leaked from the first circuitry may be determined. Thereafter, a second set of signals may be transmitted by the first set of antennas using the second radiation pattern.

### FIELD

Embodiment of the disclosure relate to wireless digital networks, and in particular, to the problem of reducing self-interference within wireless network devices.

### BACKGROUND

In a conventional wireless network device, such as a wireless access point or a wireless mesh node operating according to one or more versions of the IEEE 802.11 standards, a radio frequency (RF) receiver circuitry may not be able to properly receive wireless signals transmitted by another device, such as a client device being served, when an RF transmitter circuitry within the same wireless network device is actively transmitting on the same radio frequency because the signals transmitted by the transmitter circuitry of the wireless network device may cause significant interference in the receiver circuitry of the wireless network device. This phenomenon may be referred to hereinafter as self-interference within a wireless network device. The receiver circuitry and the transmitter circuitry may belong to the same radio module of the wireless network device, or may belong to two separate radio modules of the wireless network device (wireless network devices including more than one radio modules are increasingly common).

Methods for reducing or eliminating the intra-device self-interference may be useful under various different circumstances. For example, a wireless network device with two radio modules may be able to provide wireless data access service to client devices with one radio module while simultaneously performing channel scanning on the same frequency band with the other radio module if the self-interference caused by the radio module serving clients can be sufficiently reduced or eliminated. In another example, a radio module of a wireless network device may be enabled to simultaneously transmit and receive if the self-interference caused by the transmitter circuitry of the radio module can be sufficiently reduced or eliminated.

### BRIEF DESCRIPTION OF THE DRAWINGS

The disclosure may best be understood by referring to the following description and accompanying drawings that are used to illustrate embodiments of the disclosure by way of example and not limitation. In the drawings, in which like reference numerals indicate similar elements:

FIG. 1 illustrates an exemplary environment in which embodiments of the disclosure may be practiced.

FIG. 2 is an exemplary block diagram of logic associated with a wireless network device.

FIG. 3 is a flowchart illustrating an exemplary method for reducing or eliminating self-interference within a wireless network device.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

Disclosed herein, one embodiment of the disclosure is directed to a system, apparatus, and method for reducing self-interference within a wireless network device using channel state information feedback and beamforming techniques. The self-interference within a device may be reduced by first transmitting, by a first circuitry, a first set signals using a first radiation pattern through a first set of antennas coupled with the first circuitry. Then, based on feedback information associated with the first set of signals detected by a second circuitry of the device, a second radiation pattern to be used by the first circuitry and the first set of antennas that reduces receipt of signals by the second circuitry that are transmitted by the first set of antennas or leaked from the first circuitry may be determined. Thereafter, a second set of signals may be transmitted by the first set of antennas using the second radiation pattern.

Of course, other features and advantages of the disclosure will be apparent from the accompanying drawings and from the detailed description that follows below.

In the following description, certain terminology is used to describe features of the disclosure. For example, in certain situations, the term “logic” is representative of hardware, firmware and/or software that is configured to perform one or more functions. As hardware, logic may include circuitry having data processing or storage functionality. Examples of such circuitry may include, but is not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Logic may be software in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage. When executed by one or more processors, executable code may cause the one or more processors to perform operations according to the executable code.

Embodiments of the disclosure utilize the digital signal processing (DSP)-based explicit beamforming technique, which is specified in the IEEE 802.11n and IEEE 802.11ac standards, or slightly modified versions of it, to reduce or eliminate self-interference in a receiver circuitry caused by transmissions by a transmitter circuitry within the same wireless network device.

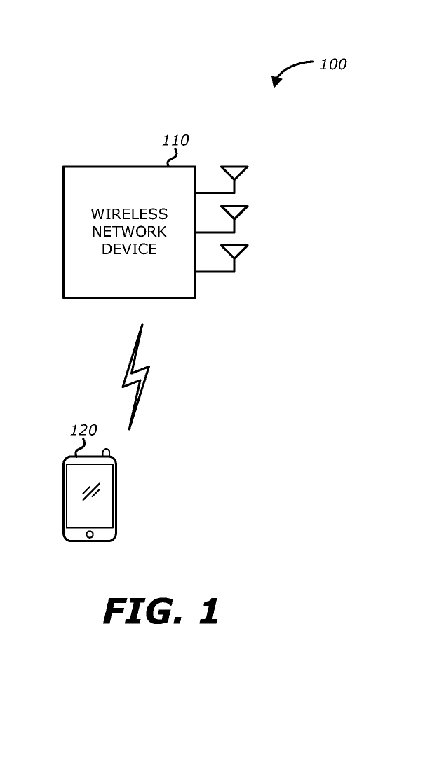

FIG. 1 illustrates an exemplary environment 100 in which embodiments of the disclosure may be practiced. The exemplary wireless network device 110 is a multiple-input multiple-output (MIMO)-capable network device that provides data access service to one or more client devices, such as the exemplary client device 120, via wireless radio frequency (RF) transmissions. Wireless network device 110 and client device 120 may operate according to one or more versions of the IEEE 802.11 standards, such as the IEEE 802.11n and IEEE 802.11ac standards. Environment 100 may include additional wireless network devices and/or client devices, and some of the additional client devices may be served by wireless network devices other than wireless network device 110 while being within communication and interference ranges of wireless network device 110. These additional devices, however, are omitted from FIG. 1 in order not to obscure the disclosure.

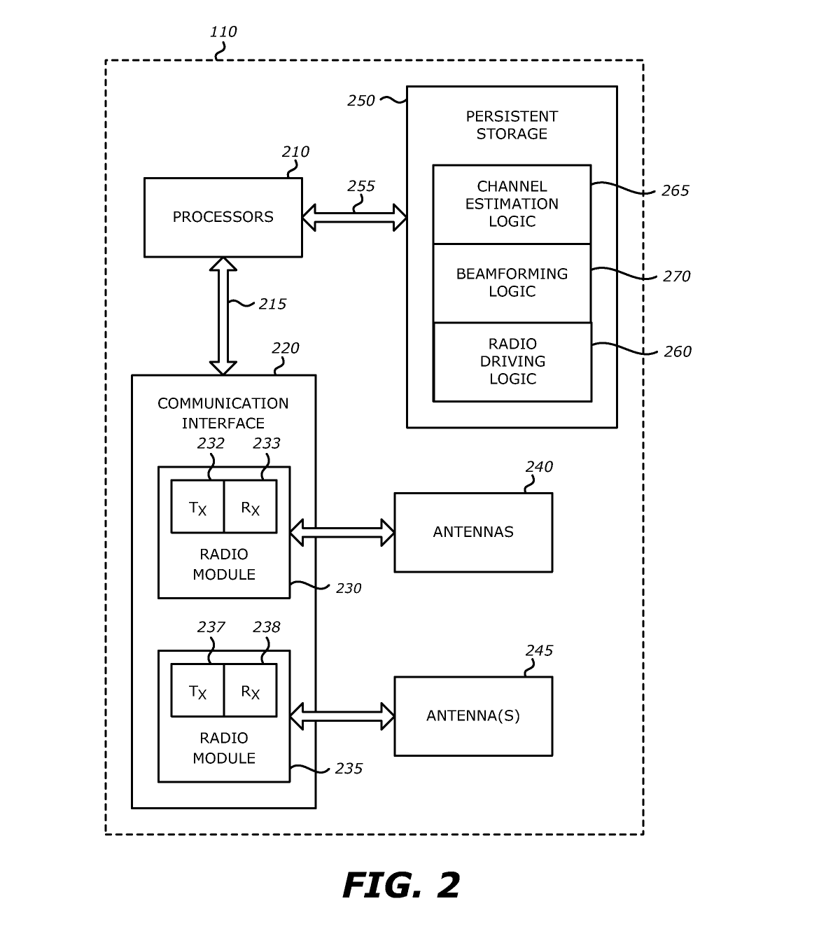

Referring now to FIG. 2, an exemplary block diagram of logic associated with wireless network device 110 is shown. The wireless network device 110 comprises one or more processors 210 that are coupled to communication interface logic 220 via a first transmission medium 215. Communication interface logic 220 enables communications with the data network (not shown), with client devices such as client device 120 of FIG. 1, and possibly with an external controller (not shown). According to one embodiment of the disclosure, communication interface logic 220 may be implemented as one or more radio modules coupled to antennas for supporting wireless communications with other devices. In the embodiment illustrated in FIG. 2, two radio modules 230 and 235 are implemented. Each radio module comprise a transmitter circuitry and a receiver circuitry: radio module 230 comprises transmitter circuitry 232 and receiver circuitry 233, while radio module 235 comprises transmitter circuitry 237 and receiver circuitry 238. Moreover, radio module 230 may be MIMO-capable and may be associated with a plurality of antennas 240 (within antennas 240, transmit and receive antennas may be shared or may be separate). Radio module 235 may be associated with one or more antennas 245 (within antennas 245, transmit and receive antennas may be shared or may be separate). In some embodiments, radio module 230 and radio module 235 may share antennas. In other words, antennas 240 and antennas 245 may be the same antennas. It should be appreciated that in alternative embodiments, communication interface logic 220 of wireless network device 110 may comprise only one radio module, such as radio module 230, or may comprise more than two radio modules. The number of radio modules and the configuration of antennas do not limit the invention. Additionally, communication interface logic 220 may be implemented as a physical interface including one or more ports for wired connectors.

Processor 210 is further coupled to persistent storage 250 via transmission medium 255. According to one embodiment of the disclosure, persistent storage 250 may include radio driving logic 260, channel estimation logic 265, and beamforming logic 270, etc., for the proper operation of wireless network device 110 including radio modules 235 and 240. Of course, when implemented as hardware, radio driving logic 260, channel estimation logic 265, and beamforming logic 270, etc. would be implemented separately from persistent memory 250.

The DSP-based explicit beamforming technique as specified in the IEEE 802.11n and IEEE 802.11ac standards allows a transmitter circuitry of a MIMO-capable transmitting device to transmit RF signals with radiation patterns that steer either a signal power maximum or a signal power minimum (null-steering) toward a receiver circuitry of a receiving device. The technique works as follows: first, the transmitter circuitry transmits a known sounding frame using a plurality of RF chains. Next, the receiver circuitry receives the sounding frame and determines how it “hears” the known sounding frame transmitted by the transmitter circuitry. Thereafter, the receiving device generates feedback information and transmits the feedback information back to the transmitting device. Depending on the implementation, the feedback information may be a channel state information (CSI) matrix, or may be a V matrix that is directly usable as a steering matrix. Last, the transmitter circuitry applies a steering matrix to its transmissions to weight its multiple transmit RF chains to create either a signal power maximum or a signal power minimum at the receiver circuitry. The steering matrix may be derived from the CSI matrix, or may be the V matrix received as the feedback information. When a signal power minimum is to be steered, the steering matrix is known as a null-steering matrix.

Embodiments of the disclosure adapts the explicit beamforming technique such that a transmitter circuitry of wireless network device 110 steers a signal power minimum toward a receiver circuitry of the same wireless network device 110 to reduce or eliminate self-interference.

In one embodiment of the disclosure, radio module 230 and radio module 235 of wireless network device 110 may be operating on the same frequency band simultaneously. Radio module 230 may be serving client devices, such as client device 120, and radio module 235 may be performing channel scanning. Therefore, for radio module 230 and radio module 235 to operate simultaneously, the intra-device self-interference caused by transmitter circuitry 232 of radio module 230 at receiver circuitry 238 of radio module 235 needs to be minimized. It should be noted that RF signals transmitted by transmitter circuitry 232 of radio module 230 may travel to receiver circuitry 238 of radio module 235 through multiple paths. For example, one such path may exist through antenna RF coupling between antennas 240 and antennas 245. As described above, in some embodiments, antennas 240 and antennas 245 may be the same antennas. In other words, RF signals may travel from transmitter circuitry 232 to receiver circuitry 238 through shared antennas. Another RF propagation path between transmitter circuitry 232 and receiver circuitry 238 may exist through unintended parasitic RF coupling as a result of RF signal leakage between the two circuitries.

To minimize the self-interference caused by transmitter circuitry 232 of radio module 230 at receiver circuitry 238 of radio module 235, transmitter circuitry 232 of radio module 230 may first transmit a set of signals including a known sounding frame with a default radiation pattern under the control of processors 210 and with the assistance of radio driving logic 260. The set of signals including the sounding frame may propagate to receiver circuitry 238 of radio module 235 through the multiple RF propagation paths described above and may be received by receiver circuitry 238 of radio module 235. Receiver circuitry 238 may receive the set of signals including the sounding frame at a signal strength that is above a noise floor calibrated for receiver circuitry 238.

Then, with the assistance of channel estimation logic 265, a channel state estimate relating to the characteristics of RF propagation from transmitter circuitry 232 of radio module 230 to receiver circuitry 238 of radio module 235 may be generated based on how receiver circuitry 238 “hears” the known sounding frame. The channel state estimate may take the form of a CSI matrix, and may be further processed into a null-steering matrix, such as a V matrix, under the control of processors 210. The channel state estimate, the CSI matrix, and/or the null-steering matrix may be hereinafter collectively referred to as feedback information.

Thereafter, under the control of processors 210, the null-steering matrix may be applied to further transmissions of transmitter circuitry 232 of radio module 230 to weight the multiple RF chains of transmitter circuitry 232 so that further transmissions of transmitter circuitry 232 may assume a new radiation pattern that steers a signal power minimum toward receiver circuitry 238 of radio module 235, and the self-interference caused by transmitter circuitry 232 of radio module 230 at receiver circuitry 238 of radio module 235 may thereby be minimized. As a result, receiver circuitry 238 of radio module 235 may receive transmissions from transmitter circuitry 232 of radio module 230 at a signal strength that is below the noise floor calibrated for receiver circuitry 238.

Therefore, receiver circuitry 238 of radio module 235 may perform channel scanning and successfully receive signals transmitted by another device while transmitter circuitry 232 of radio module 230 is simultaneously transmitting on the same frequency, and receiver circuitry 238 may receive the signals transmitted by another device at a higher signal strength than the signal strength at which receiver circuitry 239 receives the signals transmitted by transmitter circuitry 232.

In another embodiment of the disclosure, radio module 230 of wireless network device 110 may be the sole radio module of wireless network device 110 operating on an RF frequency band. In this scenario, minimizing self-interference caused by transmitter circuitry 232 at receiver circuitry 233, both of radio module 230, may enable radio module 230 to simultaneously transmit and receive on an RF frequency band. It should be noted that RF signals transmitted by transmitter circuitry 232 may travel to receiver circuitry 233 through multiple paths. For example, one such path may exist through the shared antennas 240 (or through separate transmit and receive antennas within antennas 240), and another such path may exist through unintended parasitic RF coupling between transmitter circuitry 232 and receiver circuitry 233 as a result of RF signal leakage between the two circuitries.

Similar to the embodiment described above, to minimize the self-interference caused by transmitter circuitry 232 at receiver circuitry 233 of radio module 230, transmitter circuitry 232 may first transmit a set of signals including a known sounding frame with a default radiation pattern under the control of processors 210 and with the assistance of radio driving logic 260. The set of signals including the sounding frame may propagate to receiver circuitry 233 through the multiple RF propagation paths described above and may be received by receiver circuitry 233. Receiver circuitry 233 may receive the set of signals including the sounding frame at a signal strength that is above a noise floor calibrated for receiver circuitry 233.

Then, with the assistance of channel estimation logic 265, a channel state estimate relating to the characteristics of RF propagation from transmitter circuitry 232 to receiver circuitry 233 may be generated based on how receiver circuitry 233 “hears” the known sounding frame. The channel state estimate may take the form of a CSI matrix, and may be further processed into a null-steering matrix, such as a V matrix, under the control of processors 210. The channel state estimate, the CSI matrix, and/or the null-steering matrix may be hereinafter collectively referred to as feedback information.

Thereafter, under the control of processors 210, the null-steering matrix may be applied to further transmissions of transmitter circuitry 232 to weight the multiple RF chains of transmitter circuitry 232 so that further transmissions of transmitter circuitry 232 may assume a new radiation pattern that steers a signal power minimum toward receiver circuitry 233, and the self-interference caused by transmitter circuitry 232 at receiver circuitry 233 may thereby be minimized. As a result, receiver circuitry 233 may receive transmissions from transmitter circuitry 232 at a signal strength that is below the noise floor calibrated for receiver circuitry 233.

Therefore, receiver circuitry 233 may successfully receive signals transmitted by another device while transmitter circuitry 232 is simultaneously transmitting on the same frequency, and receiver circuitry 233 may receive the signals transmitted by another device at a higher signal strength than the signal strength at which receiver circuitry 233 receives the signals transmitted by transmitter circuitry 232.

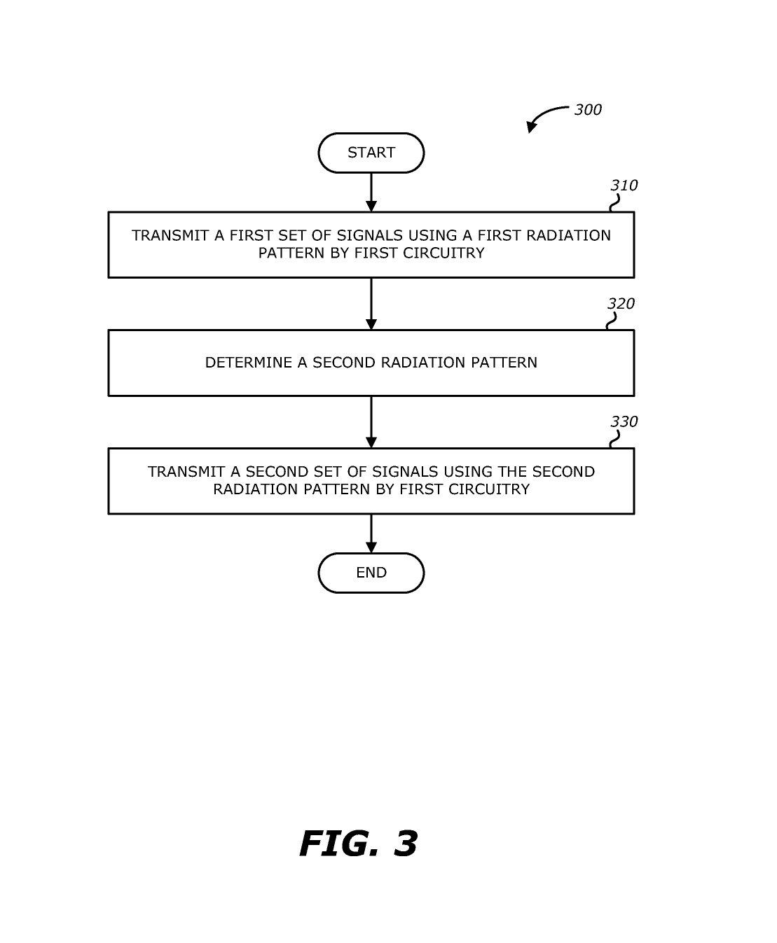

FIG. 3 is a flowchart illustrating an exemplary method 300 for reducing or eliminating self-interference within wireless network device 100. First, at block 310, a transmitter circuitry (alternatively, “first circuitry” hereinafter) may transmit a first set of signals using a first radiation pattern through a first set of antennas coupled with the first circuitry. The first circuitry may be, for example, transmitter circuitry 232 of radio module 230 of wireless network device 110, and the first set of antennas may be, for example, antennas 240. The first radiation pattern may be a default radiation pattern. Moreover, the first set of signals may include a known sounding frame.

Next, at block 320, a second radiation pattern may be determined based on feedback information associated with the first set of signals detected by a receiver circuitry (alternatively, “second circuitry” hereinafter) so that using the second radiation pattern by the first circuitry reduces receipt of signals by the second circuitry that are transmitted by the first circuitry, either through the first set of antennas or through unintended RF signal leakage. The second circuitry may receive the first set of signals at a signal strength above a noise floor calibrated for the second circuitry. The second circuitry and the first circuitry may belong to the same radio module, or may belong to two different radio modules. In the former case, the second circuitry may be receiver circuitry 233 of radio module 230 of wireless network device 110, and in the latter case, the second circuitry may be receiver circuitry 238 of radio module 235 of wireless network device 110. RF signals may propagate from the first circuitry to the second circuitry through multiple paths. For example, RF signals may propagate through antenna RF coupling, such as the coupling between separate antennas 240 and antennas 245 or the coupling through shared antennas, as described above, or through unintended parasitic RF coupling between the first circuitry and the second circuitry as a result of RF signal leakage. The feedback information may be based on how the second circuitry “hears” the first set of signals including the known sounding frame, and may be a CSI matrix, or a null-steering V matrix, etc. It should be appreciated that reducing receipt of signals by the second circuitry may be synonymous with steering a signal power minimum toward the second circuitry, which may be synonymous with creating a null at the second circuitry.

Last, at block 330, the first circuitry transmits a second set of signals using the second radiation pattern by the first set of antennas. Because the first circuitry transmits the second set of signals using the second radiation pattern, receipt of the second set of signals by the second circuitry may be reduced. Therefore, the second circuitry may receive the second set of signals at a signal strength below the noise floor calibrated for the second circuitry.

By utilizing the method, apparatus, or system described herein, self-interference within a wireless network device caused by a transmitter circuitry at a receiver circuitry is reduced, minimized, or eliminated. Thereby, a wireless network device with two or more radio modules may provide service to client devices and perform channel scanning on the same frequency band simultaneously. Additionally or alternatively, the wireless network device may be able to transmit and receive RF signals for communication purposes simultaneously on the same frequency band.

While the invention has been described in terms of various embodiments, the invention should not be limited to only those embodiments described, but can be practiced with modification and alteration within the spirit and scope of the appended claims. The description is to be regarded as illustrative rather than limiting.

1. A non-transitory computer-readable medium comprising instructions which, when executed by one or more hardware processors, cause performance of operations comprising:
transmitting, by a first set of antennas of a device currently coupled with a first circuitry, a first set of one or more signals using a first radiation pattern;
based on feedback information associated with the first set of signals detected by a second circuitry of the device, determining a second radiation pattern to be used by the first circuitry and the first set of antennas, the second radiation pattern reducing receipt of signals, by the second circuitry, that are transmitted by the first set of antennas or leaked from the first circuitry; and
transmitting, by the first set of antennas of the device, a second set of one or more signals using the second radiation pattern.

2. The non-transitory computer-readable medium of claim 1, wherein the first set of antennas are coupled with the second circuitry, and the signals detected by the second circuitry are signals detected using only the first set of antennas.

3. The non-transitory computer-readable medium of claim 1, wherein the signals detected by the second circuitry comprise signals detected using a second set of antennas coupled with the second circuitry.

4. The non-transitory computer-readable medium of claim 1, wherein the feedback information is based on the first set of signals detected from (a) the first set of antennas and/or (b) signal leakage from the first circuitry.

5. The non-transitory computer-readable medium of claim 1, wherein the first set of antennas comprise two or more antennas.

6. The non-transitory computer-readable medium of claim 1, wherein the first set of signals comprise sounding frames.

7. The non-transitory computer-readable medium of claim 6, wherein the feedback information comprises Channel State Information (CSI) associated with the sounding frames.

8. The non-transitory computer-readable medium of claim 1, wherein the first set of one or more signals are received by the second circuitry at a signal strength that is above a noise floor calibrated for the second circuitry, and wherein the second set of one or more signals are received by the second circuitry at a signal strength that is below the noise floor calibrated for the second circuitry.

9. The non-transitory computer-readable medium of claim 1, wherein the second antenna radiation pattern used by the first set of antennas is determined using a null steering matrix to create a null for the second circuitry.

10. The non-transitory computer-readable medium of claim 1, wherein the second circuitry receives a third set of signals transmitted by a second device at a higher signal strength than the second set of signals, wherein the third set of signals and the second set of signals are transmitted at approximately the same time.

11. A device comprising:
a first set of antennas;
a first circuitry currently coupled with the first set of antennas;
a second circuitry;
a controller configured to control the first circuitry and the second circuitry; and
a non-transitory memory coupled to the controller, the memory containing instructions which, when executed by the controller, cause the controller to perform operations comprising:
transmitting, by the first set of antennas of the device, a first set of one or more signals using a first radiation pattern;
based on feedback information associated with the first set of signals detected by the second circuitry of the device, determining a second radiation pattern to be used by the first circuitry and the first set of antennas, the second radiation pattern reducing receipt of signals, by the second circuitry, that are transmitted by the first set of antennas or leaked from the first circuitry; and
transmitting, by the first set of antennas of the device, a second set of one or more signals using the second radiation pattern.

12. The device of claim 11, wherein the first set of antennas are coupled with the second circuitry, and the signals detected by the second circuitry are signals detected using only the first set of antennas.

13. The device of claim 11, wherein the device comprises a second set of antennas currently coupled with the second circuitry, and wherein the signals detected by the second circuitry comprise signals detected using the second set of antennas.

14. The device of claim 11, wherein the feedback information is based on the first set of signals detected from (a) the first set of antennas and/or (b) signal leakage from the first circuitry.

15. The device of claim 11, wherein the first set of antennas comprise two or more antennas.

16. The device of claim 11, wherein the first set of signals comprise sounding frames.

17. The device of claim 16, wherein the feedback information comprises Channel State Information (CSI) associated with the sounding frames.

18. The device of claim 11, wherein the first set of one or more signals are received by the second circuitry at a signal strength that is above a noise floor calibrated for the second circuitry, and wherein the second set of one or more signals are received by the second circuitry at a signal strength that is below the noise floor calibrated for the second circuitry.

19. The device of claim 11, wherein the second antenna radiation pattern used by the first set of antennas is determined using a null steering matrix to create a null for the second circuitry.

20. The device of claim 11, wherein the second circuitry receives a third set of signals transmitted by a second device at a higher signal strength than the second set of signals, wherein the third set of signals and the second set of signals are transmitted at approximately the same time.
